(19) United States
(12) Patent Application Publication
(10) Pub. No.: US 2007/0276223 A1
(43) Pub. Date: Nov. 29, 2007

(54) Method And Imaging Diagnostic Apparatus For Finding A Stenosis

(75) Inventor: Hubrecht Lambertus Tjalling De Bliek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,423

(22) PCT Filed: Mar. 24, 2005
(86) PCT No.: PCT/IB05/51025

§ 371 Date: Sep. 28, 2006

(30) Foreign Application Priority Data
Apr. 1, 2004 (EP) 04101360.8

(51) Int. Cl. G06T 11/00

(52) U.S. Cl. 600/410

(57) ABSTRACT

The invention further relates to an imaging diagnostic apparatus (500), notably a CT apparatus or an MR apparatus, for carrying out the method of claim 1, which apparatus includes an imaging unit (506, 500) for the acquisition of course data of an object to be examined (516) and also includes a program-controlled reconstruction unit (506) which is designed to reconstruct volume image data from the coarse data, the volume image data consisting of a plurality of voxels, each respective voxel comprising a respective intensity value, and defining a path through volume image data; and is further designed to calculate a two-dimensional image including the respective intensity values of the plurality of voxels; calculate a new intensity value for at least one voxel on the path using the intensity value of this at least one voxel; calculate a new two-dimensional image including the new intensity value; and sequentially display the original- and new two-dimensional image. The invention further relates to a method, a computer program product, a computer readable medium, and a system

The invention relates to a method of displaying a two-dimensional image of a segment of a tubular structure from a three-dimensional volume image data set of the tubular structure, the three-dimensional volume image data set comprising a plurality of voxels, each respective voxel comprising a respective intensity value, the method comprising: defining a path through the segment of the tubular structure.

The invention further relates to an imaging diagnostic apparatus, notably a CT apparatus or an MR apparatus, for carrying out the method of claim 1, which apparatus includes an imaging unit for the acquisition of coarse data of an object to be examined and also includes a program-controlled reconstruction unit which is designed to reconstruct volume image data from the coarse data, the volume image data consisting of a plurality of voxels, each respective voxel comprising a respective intensity value, and defining a path through the volume image data; and is further designed to calculate a two-dimensional image including the respective intensity values of the plurality of voxels.

The invention further relates to a computer program product designed to perform such a method.

The invention further relates to a computer readable medium having stored thereon instructions for causing one or more processing units to perform such a method.

The invention further relates to a system comprising a suitably programmed computer of a workstation arranged to comprise instructions for causing one or more processing units to perform such a method, and having means to display images processed according to said method.

An embodiment of such a method and imaging diagnostic apparatus is known from WO 00/41134. Here an image processing method is disclosed for processing an image representing a tubular structure having walls. In general, the visualization of volumetric medical image data plays a crucial part in diagnosis operation and therapy planning by enabling the visualization of the regions of the body without physically penetrating these regions. The regions are preferably tubular structures having walls such as vessels or the colon of a patient. The disclosed image processing method comprises steps for determining a flight path inside this tubular structure between a first and a second predetermined end point. Said flight path being both the shortest path between said end points and the farthest from the structure walls. The steps may comprise locating the structure wall points, determining a surface at a predetermined constant distance from said wall points, inside the structure, for forming a central region, and determining, in said central region, the shortest path between the first and second end points. The method allows building a virtual 3-D interior view of the tubular structure along this path. The method further permits visualizing the inside of anatomical objects in 3-D CT or MR images in a virtual way and in an automated manner. Therefore, the method can be applied to virtual endoscopy. However, when for example a vessel must be analyzed for a possible stenosis, a radiologist must visually inspect the whole interior view of the vessel, which is time consuming.

It is an object of the invention to provide a method that analyzes the interior of a tubular structure for a stenosis in an improved way. In order to achieve this object, the method according to the opening paragraph comprises calculating a new intensity value for at least one voxel on the path using the intensity value of this at least one voxel; calculating a new two-dimensional image including the new intensity value; and sequentially displaying the original- and new two-dimensional image of the segment of the tubular structure. By sequentially displaying an original and new two-dimensional image of the segment of a tubular structure at the same position along the path, a discrepancy between the images is easily detected by a radiologist because this discrepancy draws the attention of the radiologist.

An embodiment of the invention comprises a plurality of iterations wherein in each iteration the method comprises calculating an additional new intensity value for the at least one voxel on the path using the intensity value of at least one neighboring voxel; calculating an additional new two-dimensional image including the additional new intensity value and; the method further comprises sequentially displaying the additional new two-dimensional image in addition to displaying the original- and new two-dimensional image of the segment of the vessel. By taking more neighboring voxels into consideration that are adjacent to the voxels on the path, i.e. taking a larger kernel into account, the influence of the voxels that have extraordinary values is increased within the newly calculated image. Typically, the influence of voxels that represent, for example, a stenosis in a vessel will be increased, since these values differ from the values of those voxels that represent an area within the vessel without a stenosis, i.e. those voxels that represent blood. By sequentially displaying the images at the same path position with an increasing kernel, the stenosis causes a blinking effect within the images that can be detected more easily by a physician.

A further embodiment of the invention comprises displaying the new intensity value in a distinctive color. By displaying the extraordinary, stenosis, voxel values in a distinctive color, for example green, the blinking effect becomes more apparent, thereby attracting more attention for the region within the vessel.

A further embodiment of the invention comprises displaying the distinctive color if the new intensity value relates to a threshold value. By incorporating a threshold before using a distinctive color for displaying a stenosis, the influence of normal anatomical variations can be taken into account. Thereby, it can be prevented that attention is drawn to normal variations within the thickness of the wall of the vessel or other normal anatomical variations.

Within a further embodiment of the invention the new intensity value is one of a minimum intensity value, a maximum intensity value or an average intensity value of the at least one voxel on the path and/or its at least one neighboring voxel. By allowing a different calculation of the new intensity value, the visualization of a stenosis within a vessel can be fine-tuned to the used imaging technology for acquiring the images of the vessel. For example, the specific acquisition apparatus properties, like a CT,MR, a 3-Dimensional Rotational Angiography (3D-RA), Positron Emission Tomography (PET), or Single Photon Emission Computed Tomography (SPECT) imaging apparatus can be taken into account. Further, the used contrast agent, and the imaging technique like bright blood imaging or black blood imaging can be taken into account.

Within a further embodiment of the invention the two-dimensional images are curvi-linear reformatted images along the path through the segment of the tubular structure.

Within a further embodiment of the invention the two-dimensional images are a Maximum or Minimum Intensity Projection of the segment of the tubular structure. By using different formatting techniques, the most suitable imaging technique for the vessel to be analyzed can be chosen.

Within a further embodiment of the invention the tubular structure is one of a vessel, a colon or a trachea.

It is an object of the invention to provide an imaging diagnostic apparatus that analyzes the interior of a tubular structure in an improved way In order to achieve this object, the imaging diagnostic apparatus according to the opening paragraph, comprises a program-controlled reconstruction unit which is further designed to calculate a new intensity value for at least one voxel on the path using the intensity value of this at least one voxel; calculate a new two-dimensional image including the new intensity value; and sequentially display the original- and new two-dimensional image.

These and other aspects of the invention will be apparent from and elucidated with reference to the embodiments described hereinafter as illustrated by the following Figs.

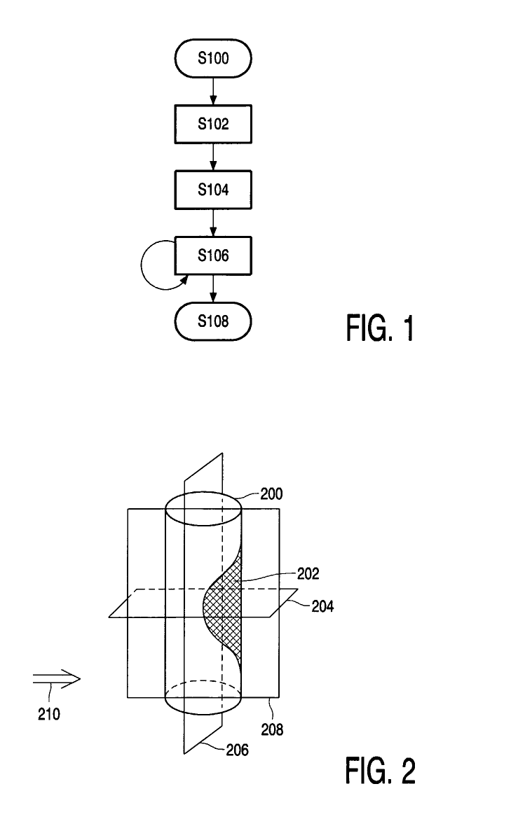

FIG. 1 illustrates the main steps of the method according to the invention;

FIG. 2 illustrates a schematic view of a vessel comprising a stenosis;

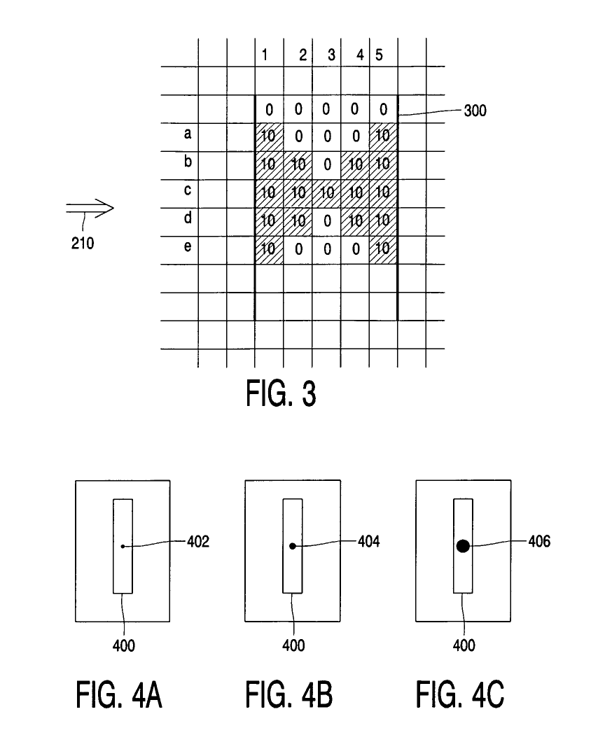

FIG. 3 illustrates a schematic view of a path through the vessel;

FIGS. 4A, 4B, and 4C illustrate the resulting images according to the method of the invention;

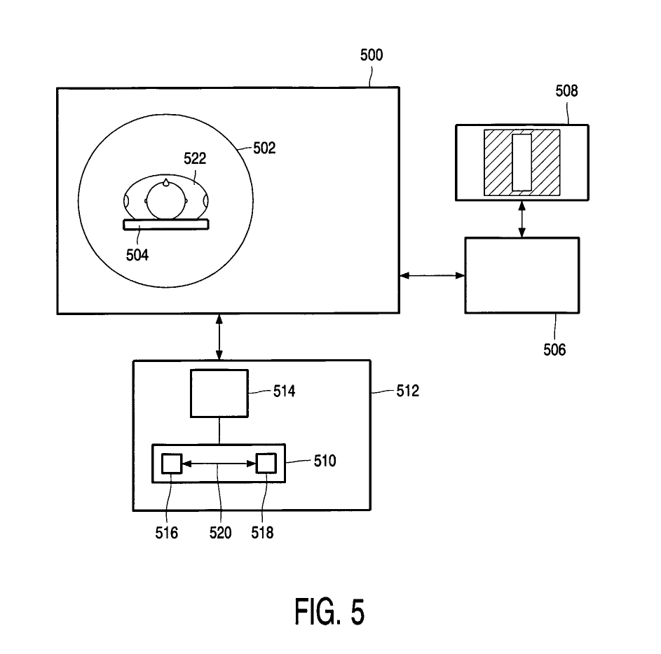

FIG. 5 illustrates a medical apparatus according to the invention in a schematic way.

FIG. 1 illustrates the main steps of the method according to the invention. Within the first step S100, the method is initialized. During this initialization step, a user, for example a technician, physician or radiologist, can choose the image set of the vessel to be analyzed. This image set comprises 2-Dimensional images that together form a volumetric, 3-Dimensional, image set of the vessel to be analyzed. A 2-D image comprises of pixels (picture elements) and a 3-D image comprises of voxels (volume elements). Since the method according to the invention is related to volumetric image sets, the term “voxels” will be used below, even if the term “pixels” would be more appropriate. It is also possible that a segment of a vessel is chosen or that a vessel tree is chosen.

FIG. 2 illustrates a schematic view of a part of a vessel comprising a stenosis. The vessel 200 comprises a stenosis 202 resulting in a smaller diameter of the vessel surrounding the stenosis. The arrow 210 indicates the viewing direction and 204 indicates the transverse plane, 206 indicates the frontal plane and 208 indicates the sagittal plane.

Now, continuing with reference to FIG. 1, within the next step S102, a path, or centerline, through the vessel structure is defined. Hereto, standard path tracking technique is used like for example the path tracking technique as previously described with reference to WO00/41134. Other path tracking techniques can be used too, like for example as disclosed in: “Efficacy of automatic path tracking in virtual colonoscopy” by Roel Truyen, Bert Verdonck, Thomas Deschamps, Philippe Lefere and Stefaan Gryspeerdt in CARS 2001, or as disclosed in “Clinical Evaluation of an automatic path tracker for virtual colonscopy” by Roel Truyen, Thomas Deschamps, Laurent D. Cohen, or as disclosed in EP 1 308 890 A1. The path tracking techniques therein described can also be applied to vessel structures, and trees of vessels. The user of the system can create the path manually, or the path can be created automatically.

FIG. 3 illustrates a schematic view of a path through the images of the vessel. Reference numeral 300 indicates the vessel. The images comprise of voxels each having an intensity value. For easy of explanation, the individual voxels are referenced by definition of their matrix position. The columns are indicated by the indices 1 to 5, whereas the rows are indicated by the indices a to e. Further, the voxels contributing to the stenosis have intensity value 10 and the voxels not contributing to the stenosis have intensity value 0. For ease of explanation, the path comprises of those voxels within column 3, i.e. those voxels at matrix positions a3, b3, c3, d3, and e3. Note, that the path preferably follows the center of the vessel lumen. The voxels contributing to the stenosis form two 3-Dimensional pyramids with a base of 5×5 voxels and a height of 3 voxels as illustrated within FIG. 3.

The user can determine a number of parameters that influence the detection of a stenosis by the method according to the invention, such as:

the visualization technique to be used for the image, i.e. the user can choose if the images must be displayed as an multi-planar reformatted image (MPR-image), as a maximum intensity projection (MIP) or as an minimum intensity projection (mIP);

the orientation of the displayed image with respect to the path when appropriate;

how the intensity values of the different voxels must be taken into account, for example if the average intensity value, the minimal intensity value or the maximum intensity value must be taken into account;

the windowing, like window-width and/or window-level of the image; etc.

Continuing with reference to FIG. 1, within the next step S104, the image of the vessel structure is displayed according to the chosen parameters.

Within the step S106, the method determines for each voxel (a3, b3, c3, d3, and e3) on the path its new intensity value. This step S106 is performed according to a number of iterations. Within each iteration a new intensity value is calculated and a resulting image is displayed. The new intensity value depends upon the intensity value of the voxel itself, the intensity values of neighboring voxels, and the chosen parameters by the user. Assume that the user has chosen that the average intensity value must be calculated. Within each iteration the number of neighboring voxels is increased. Initially, only the intensity value of the voxel on the path is taken into account. In a next iteration a kernel of neighboring voxels within the plane perpendicular to the path is taken into account. In a next iteration a larger kernel of neighboring voxels is taken into account, until a predefined maximum kernel size has been reached. This maximum kernel size can be set by the user and can depend for example upon the diameter of the part of the vessel structure under investigation. The kernel may have any arbitrary shape, e.g. circular or square. For the current example, a square kernel is used and the new intensity value is shown in the next table:

| Kernel (voxel × voxel) | 1 × 1 | 3 × 3 | 5 × 5 |
|---|---|---|---|
| Row A | 0 | 0 | 100/25 |
| Row B | 0 | 60/9 | 160/25 |
| Row C | 10 | 70/9 | 170/25 |
| Row D | 0 | 60/9 | 160/25 |
| Row E | 0 | 0 | 100/25 |

This new intensity value preferably is written in a new volume at the positions of the “old” intensity values that contributed to the calculation of this new intensity value. The resulting image incorporating the new intensity value of each iteration is subsequently displayed. Therefore, each iteration results in a new image. By subsequently displaying the image of each iteration a blinking effect is experienced by the user at the position of the stenosis as illustrated in FIGS. 4A, 4B, and 4C. FIG. 4A shows the initial original image of the vessel 400. As illustrated, a distinguishing structure 402 is shown in image corresponding to the kernel size. The next FIG. 4B shows a subsequent image of the vessel 400 with an enlarged kernel size taking neighboring voxels into account resulting in a next distinguishing structure 404 corresponding to the kernel size. The last FIG. 4C shows a further subsequent image of the vessel 400 with a larger kernel taking neighboring voxels into account resulting in a distinguishing structure 406 corresponding to this larger kernel size.

In order to make the blinking effect more apparent, the newly calculated intensity values can be displayed in a distinct color, like red, green, blue etc. The color, the intensity and other effects can be chosen depending upon a number of criteria. For example, a distinguishing color may only be used if the new intensity values exceed a certain threshold suitable for the acquisition technique. Different criteria can thus be chosen depending upon the contrast agent that has been used, if bright blood imaging or black blood imaging is used, the windowing of the resulting images, etc. Likewise, the color can become more intense if the difference between the new values and the old values exceed a certain threshold or meets other criteria. It is further possible, that the user can fine-tune this threshold and other criteria.

Within step S108, the method terminates.

FIG. 5 illustrates a medical apparatus 500 according to the invention in a schematic way. The medical apparatus 500 is an MR acquisition device that comprises a magnet 502 and a patient table 504 that can be positioned within the magnetic field of the magnet 502. The patient table 504 supports the patient 522 during acquisition of coarse image data of the patient. The coarse image data is applied to a microcomputer 506, which reconstructs volumetric image data of the coarse image data. The computer is programmed in such a manner that in conformity with the invention it forms a sequence of two-dimensional images from the reconstructed volume image data, said images being displayed on the display unit 508 of the computer. Alternatively, the reconstructed volumetric image data can be transferred to an image processing system 510 for processing the data according to the method of the invention. This image processing system 510 may be a suitably programmed computer of a workstation 512 having a screen 514, a microprocessor 518, a general purpose memory 516 like random access memory (RAM) that are being communicatively connected to each other through a software bus 520. The memory 516 comprises computer readable software code designed to perform the method according to the invention as previously described. It is further possible to download the computer readable software from a storage device like a compact disk (CD) etc. or to download the computer readable software as such from the Internet into the memory of the workstation. Therefore, the workstation comprises a suitable storage reading device, like a CD-drive, that can read the software from the storage device. This CD-drive is then operatively connected to the software bus too. Within the previous example, the invention is described with reference to an MR acquisition device. However, the invention is not limited to an MR acquisition device, but extends to all imaging devices capable of reproducing volumetric image data, like for example 3D-RA, CT, PET, SPECT, etc.

The order in the described embodiments of the method of the current invention is not mandatory, a person skilled in the art may change the order of steps or perform steps concurrently using threading models, multi-processor systems or multiple processes without departing from the concept as intended by the current invention.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the system claims enumerating several means, several of these means can be embodied by one and the same item of computer readable software or hardware. The mere fact that certain measures are recited in mutually different dependent claims does not indicate that a combination of these measures cannot be used to advantage.

1. A method of displaying a two-dimensional image of a segment of a tubular structure (200) from a three-dimensional volume image data set of the tubular structure, the three-dimensional volume image data set comprising a plurality of voxels, each respective voxel comprising a respective intensity value the method comprising:
defining a path through the segment of the tubular structure (200);
calculating a new intensity value for at least one voxel on the path using the intensity value of this at least one voxel;
calculating a new two-dimensional image including the new intensity value; and
sequentially displaying the original- and new two-dimensional image of the segment of the tubular structure.

2. A method according to claim 1, comprising a plurality of iterations wherein in each iteration the method comprises
calculating an additional new intensity value for the at least one voxel on the path using the intensity value of at least one neighboring voxel;
calculating an additional new two-dimensional image including the additional new intensity value and; the method further comprises
sequentially displaying the additional new two-dimensional image in addition to displaying the original- and new two-dimensional image of the segment of the tubular structure.

3. A method according to claim 1, wherein the new intensity value is displayed in a distinctive color.

4. A method according to claim 1, wherein the distinctive color is displayed if the new intensity value relates to a threshold value.

5. A method according to claim 1, wherein the new intensity value is one of a minimum intensity value, a maximum intensity value or an average intensity value of the at least one voxel on the path and/or its at least one neighboring voxel.

6. A method according to claim 1, wherein the two-dimensional images are curvi-linear reformatted images along the path through the segment of the tubular structure.

7. A method according to claim 1, wherein the two-dimensional images are a Maximum or Mimimum Intensity Projection of the segment of the tubular structure.

8. A method according to claim 1, wherein the tubular structure is one of a vessel or a colon or a trachea.

9. An imaging diagnostic apparatus (500), notably a CT apparatus or an MR apparatus, for carrying out the method of claim 1, which apparatus includes an imaging unit (506, 500) for the acquisition of coarse data of an object to be examined (516) and also includes a program-controlled reconstruction unit (506) which is designed to reconstruct volume image data from the coarse data, the volume image data consisting of a plurality of voxels, each respective voxel comprising a respective intensity value, and defining a path through volume image data; and is further designed to
calculate a two-dimensional image including the respective intensity values of the plurality of voxels;
calculate a new intensity value for at least one voxel on the path using the intensity value of this at least one voxel;
calculate a new two-dimensional image including the new intensity value; and
sequentially display the original- and new two-dimensional image.

10. A computer program product designed to perform the method of claim 1.

11. A computer readable medium having stored thereon instructions for causing one or more processing units to perform the method of claim 1.

12. A system (510) comprising a suitably programmed computer of a workstation (512) comprising storage means (516) arranged to comprise instructions for causing one or more processing units to perform the method of claim 1, and having display means (514) for displaying images processed according to said method.
